(19) United States
(12) Patent Application Publication
(10) Pub. No.: US 2008/0020644 A1
(43) Pub. Date: Jan. 24, 2008

(54) Universal housing for a plug-type connector

(75) Inventor: Edwin Haas, Hausen (DE)

Correspondence Address: LERNER GREENBERG STEMER LLP, P O BOX 2480, HOLLYWOOD, FL, 33022-2480, US

(73) Assignee: Wieland Electric GmbH

(21) Appl. No.: 11/880,500

(22) Filed: Jul. 23, 2007

(30) Foreign Application Priority Data
Jul. 22, 2006 (DE) 20 2006 011 299.5

(51) Int. Cl. H01R 9/03

(52) U.S. Cl. 439/610

(57) ABSTRACT

A universal housing with a plug-type connector has a high leakproofness rating. The universal housing has a base shell and a cover shell which is placed onto the base shell. The plug-type connector includes a plug part and a socket part, the socket part is associated with the base shell or the cover shell, and the plug part is associated with the respective other shell. In each case one adapter, whose outer contour is matched to the inner contour of the base shell or the cover shell, and whose inner contour is configured to be complementary to the outer contour of the socket part or plug part, is inserted into the base shell and into the cover shell. Owing to a modification of the adapter, the universal housing can therefore be matched to various plug-type connectors and seals them safely.

### CROSS-REFERENCE TO RELATED APPLICATION

This application claims the priority, under 35 U.S.C. § 119, of German application DE 20 2006 011 299.5, filed Jul. 22, 2006; the prior application is herewith incorporated by reference in its entirety.

### BACKGROUND OF THE INVENTION

### Field of the Invention

The invention relates to a universal housing for a plug-type connector.

Such an electrical plug-type connector is described in many embodiments, for example, in international patent disclosure WO 2004/034516 A2, corresponding to U.S. patent disclosure 2005/0233639 A1. If such a plug-type connector is used under extreme weathering conditions, for example in offshore areas, a particularly high leakproofness rating is required. Such a plug-type connector has, for example, the leakproofness ratings NEMA 6P and IPX 7 with respect to the sealing from the ingress of moisture. In the United States and in Canada, extreme requirements as regards the prevention of flammability are also placed on a housing. Account is therefore taken of the fact that fires can easily occur in unsupervised areas. In particular when laying pipelines in which so-called heat-tracing elements are connected, which have the task of keeping the medium to be transported in the pipeline liquid at low temperatures, it is necessary to ensure that fires (for example owing to insulation breakdown) are prevented. These requirements as regards the prevention of flammability are also met by using these plug-type connectors in other areas, for example in oil refineries or else on oil rigs, in which fires can easily occur. If an electrically conductive connection is completely melted, this may result in a flashover and trigger a fire or intensify its effect.

According to the prior art, it is therefore necessary, for any configuration of an electrical plug-type connector which is intended to be used in offshore areas, to develop a housing which meets the criteria as regards high leakproofness and poor flammability. This is associated with a high degree of complexity.

### SUMMARY OF THE INVENTION

It is accordingly an object of the invention to provide a universal housing for a plug-type connector which overcomes the above-mentioned disadvantages of the prior art methods of this general type, which has a high leakproofness rating and can be produced in a simple manner.

With the foregoing and other objects in view there is provided, in accordance with the invention, a universal housing having a high leakproofness rating. The universal housing includes a base shell having an inner contour; a cover shell having an inner contour and placed onto the base shell; and a plug-type connector having a plug part with an outer contour and a socket part with an outer contour. The socket part is associated with the base shell or the cover shell, and the plug part is associated with the other of the base shell and the cover shell. Adapters are provided and each have an inner contour and an outer contour. One of the adapters is inserted into each of the base shell and the cover shell. The outer contour of the adapters are matched to the inner contour of the base shell and the cover shell, and the inner contour of the adapters are complementary to the outer contour of the socket part and of the plug part.

In this regard, the plug-type connector containing a plug part and a socket part has a universal housing, which includes a base shell and a cover shell, which is placed onto the base shell. In this case, the socket part is associated with the base shell or the cover shell, and the plug part is associated with the respective other shell. In each case one adapter, whose outer contour is matched to the inner contour of the base shell or the cover shell, and whose inner contour is configured to be complementary to the outer contour of the socket part or plug part, is inserted into the base shell and the cover shell.

Plug-type connectors having different configurations can therefore be introduced into one and the same universal housing merely by adapting the two adapters, the plug part and the socket part of the plug-type connectors having different outer contours. In addition, the high degree of leakproofness is achieved by the universal housing such that conventional plug-type connectors can be inserted into the universal housing. It is therefore possible for plug-type connectors to be used without any particular leakproofness properties which are produced in high production numbers and therefore in a cost-effective manner. Adapting the actual plug-type connector as regards its housing so as to achieve a high leakproofness rating is no longer necessary. A plug-type connector having a high leakproofness rating can therefore be produced in a simple and cost-effective manner.

Preferably, the adapter has a substantially hollow-cylindrical geometry. First, account is therefore taken of the fact that conventional plug-type connectors generally have a cylindrical geometry as the outer contour. Second, owing to the adapter being formed as a hollow cylinder, both simple insertion of a plug part or a socket part is ensured and also simple insertion of the adapter into the base shell or into the cover shell is ensured.

Advantageously, the adapter has reinforcing ribs on its outer sheath. In this way, the intrinsic weight is reduced in comparison with an embodiment formed of a solid material and savings are made on materials given the same mechanical strength. In addition, no severe forces are generally acting on the adapter. Instead, it primarily has a retaining and spacing function for the plug-type connector which has been inserted into the universal housing.

In an advantageous development, the two adapters for the base shell and the cover shell are identical. This results in cost savings during manufacture. If, for example, the two adapters are formed as plastic injection-molded parts, only one mold needs to be produced for the injection-molding. In a development, the base shell contains a socket housing and an end piece. In a similar manner to this, the cover shell expediently contains a plug housing and an end piece. Owing to this two-part embodiment of the base shell and the cover shell, the introduction of the adapter with the socket part or plug part inserted therein is significantly simplified since the interior of the base shell or cover shell is more accessible.

Expediently, the end piece is screwed once or a plurality of times to the socket housing or the plug housing. In this way, particularly simple assembly of the end piece with the socket housing for the base shell or the end piece with the plug housing for the cover shell is possible.

Advantageously, the two end pieces for the plug housing and the socket housing are identical. In this way, more cost-effective manufacture of identical parts is achieved.

In a development, the adapter can be inserted completely into the plug housing or into the socket housing in the longitudinal direction. It is therefore merely necessary to match the outer contour of the adapter to the inner contour of the plug housing or of the socket housing. However, at the same time the installation-friendly nature is maintained by the two-part configuration.

Advantageously, the end piece, which is screwed to the socket housing or to the plug housing, has a cable bushing. The cable which is connected to the plug part or to the socket part of the plug-type connector is therefore also integrated in the universal housing. In this case, the outer sheath of the cable bears against the inner wall of the cable bushing and therefore ensures that the interior of the base shell and/or of the cover shell is sealed.

In a development, the base shell has a bayonet-type closure at its fitting end for positioning the cover shell by a rotary movement. In the process, in each case at least one guide pin, which is disposed at the fitting end of the cover shell, for guiding and fixing purposes engages in a corresponding groove. In this way, it is ensured that a plug-type connection is produced in a simple manner and quickly even under very adverse conditions, as prevail, for example, in offshore areas.

The universal housing is preferably manufactured from a metal, with the result that, in addition to the high leakproofness rating, poor flammability is also realized.

Other features which are considered as characteristic for the invention are set forth in the appended claims.

Although the invention is illustrated and described herein as embodied in a universal housing for a plug-type connector, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, exploded perspective view of a universal housing surrounding a plug-type connector; and

FIG. 2 is a diagrammatic, perspective view of an assembled universal housing with the plug-type connector.

### DETAILED DESCRIPTION OF THE INVENTION

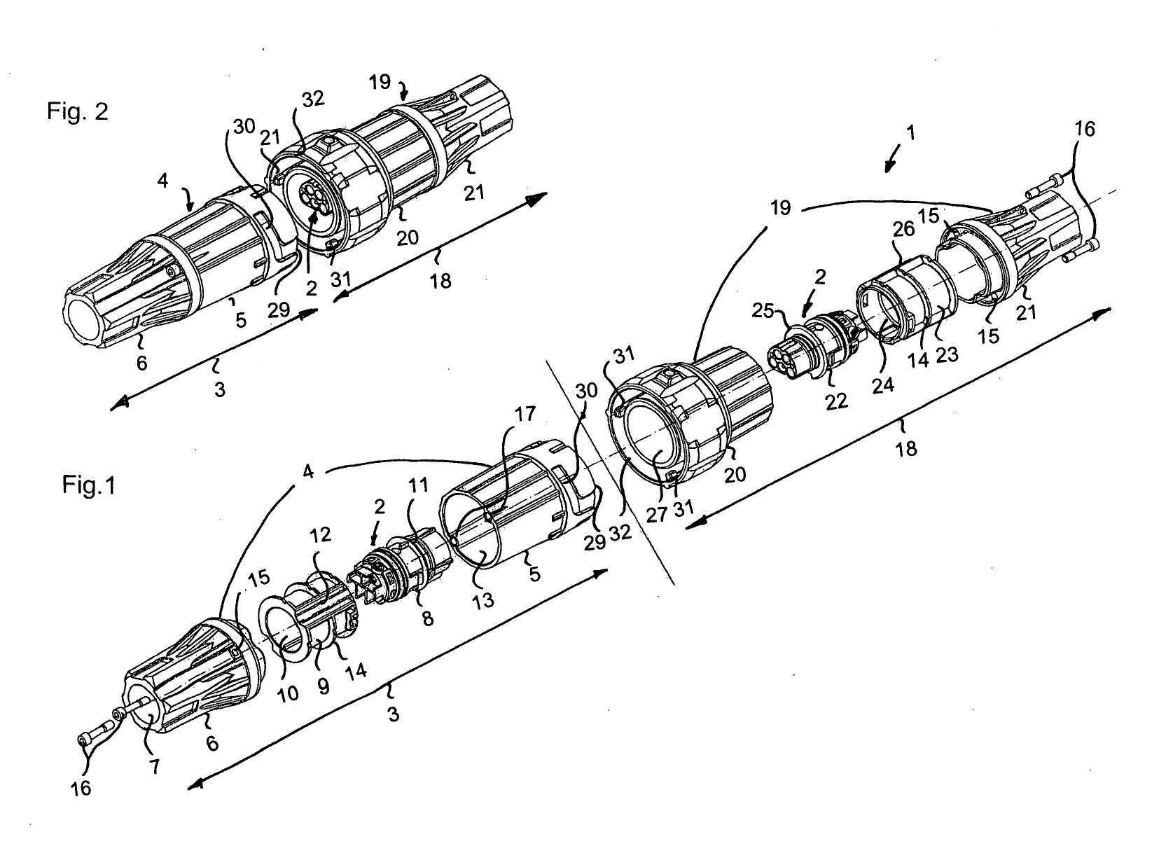

Referring now to the figures of the drawing in detail and first, particularly, to FIG. 1 thereof, there is shown a universal housing 1 having a plug-type connector 2 disposed therein. A socket side 3 has a base shell 4, which includes a socket housing 5 and an end piece 6. In order to fit the socket side 3, first a non-illustrated cable is guided through a cable bushing 7 of the socket-side end piece 6. The cable is connected to a socket part 8 of the plug-type connector 2. The cable may also be provided ready-fitted on the socket part 8. An adapter 9 is pushed onto the socket part 8, an inner contour 10 of the adapter 9 corresponding to an outer contour 11 of the socket part 8. Then, the adapter 9 is inserted into the socket housing 5. In this case, the outer contour 12 of the adapter 9 corresponds to the inner contour 13 of the socket housing 5. The socket housing 5 is in this case configured such that the adapter 9 with the socket part 8 held by the adapter can be inserted completely into the socket housing 5.

In order to increase its mechanical robustness, the adapter 9 has reinforcing ribs 14, which increase the mechanical strength of the adapter 9. Once the adapter 9 with the socket part 8 contained therein has been inserted into the socket housing 5, the end piece 6 is screwed to the socket housing 5. For this purpose, the end piece 6 has two holes 15, through which in each case one screw 16 is guided and is screwed to a corresponding thread 17 in the socket housing 5.

A plug side 18 has a similar configuration to the socket side 3. The plug side 18 has a cover shell 19, which includes a plug housing 20 and an end piece 21. For fitting purposes, first a non-illustrated cable is guided through a cable bushing 7 of the end piece 21 and connected to the plug part 22 or a plug part 22, which has already been fitted with a cable, is introduced into the end piece 21. The plug part 22 is inserted into an adapter 23. In this case, an inner contour 24 of the adapter 23 corresponds to the outer contour 24 of the plug part 22. The adapter 23 with the plug part 22 inserted therein for its part is finally inserted into the plug housing 20, the outer contour 26 of the adapter 23 corresponding to the inner contour 27 of the plug housing 20.

The adapter 23 of the plug side 18 is also configured such that it can be inserted completely into the plug housing 20 with the plug part 22 located in it.

Once the adapter 23 has been inserted into the plug housing 20, the end piece 21 is screwed to the plug housing 20. For this purpose, the end piece 21 has two holes 15, through which screws 16 are guided. The screws 16 are screwed to the plug housing 20 with in each case one thread 17.

FIG. 2 shows the ready-fitted universal housing 1 having the plug-type connector 2, which is disposed therein and is held by the two adapters 9 and 23. In order to produce a plug-type connection, the base shell 4 is pushed together with the cover shell 19 in the longitudinal direction 28. In the process, a bayonet-type closure, which is disposed at the fitting end 29 of the socket housing 5, engages with in each case one groove 30 in each case one corresponding guide pin 31 at the fitting end 32 of the plug housing 20. At the same time, the electrical connection is produced by the socket part 8 being plugged together with the plug part 22.

Owing to a rotary movement substantially transversely with respect to the longitudinal direction 28, the cover shell 19 being rotated with respect to the base shell 4, in each case one guide pin 31 runs along its corresponding groove 30. In this way, securing and fixing of the connection between the base shell 4 and the cover shell 19 is achieved.

The embodiment of the universal housing 1 ensures that the plug-type connector located therein is safely protected from moisture. Since the base shell 4 and the cover shell 19 are manufactured from an aluminum material, the plug-type connection is also safely protected from the effect of heat.

1. A universal housing having a high leakproofness rating, the universal housing comprising:
a base shell having an inner contour;
a cover shell having an inner contour and placed onto said base shell;
a plug-type connector having a plug part with an outer contour and a socket part with an outer contour, said socket part being associated with one of said base shell and said cover shell, and said plug part being associated with the other of said base shell and said cover shell; and
adapters each having an inner contour and an outer contour, one of said adapters inserted into each of said base shell and said cover shell, said outer contour of said adapters matched to said inner contour of said base shell and said cover shell, and said inner contour of said adapters being complementary to said outer contour of said socket part and of said plug part.

2. The universal housing according to claim 1, wherein said adapters substantially have a geometry of a hollow cylinder.

3. The universal housing according to claim 1, wherein said adapter has an outer sheath and reinforcing ribs disposed on said outer sheath.

4. The universal housing according to claim 1, wherein said adapters for the said base shell and said cover shell are identical.

5. The universal housing according to claim 1, wherein said base shell has a socket housing and an end piece.

6. The universal housing according to claim 5, wherein said cover shell has a plug housing and an end piece.

7. The universal housing according to claim 5, further comprising at least one screw connection connecting said end piece to said socket housing.

8. The universal housing according to claim 6, further comprising at least one screw connection connecting said end piece to said plug housing.

9. The universal housing according to claim 6, wherein said end piece for said cover shell and said base shell are identical.

10. The universal housing according to claim 6, wherein said respective adapter can be inserted completely into said plug housing and into said socket housing in a longitudinal direction.

11. The universal housing according to claim 6, wherein said end piece of each of said base shell and said cover shell has a cable bushing.

12. The universal housing according to claim 1, wherein:
said cover shell has a fitting end with a guide pin; and
said base shell has a fitting end with a groove formed therein and a bayonet-type closure for positioning said cover shell by a rotary movement, in each case said guide pin, disposed at said fitting end of said cover shell, provided for guiding and fixing purposes engages in said groove for closing said bayonet-type closure.

13. The universal housing according to claim 1, wherein said base shell and said cover shell are made from a material selected from the group consisting of metal and a metal alloy.

14. A universal housing for a plug-type connector and having a high leakproofness rating, the plug-type connector having a plug part with an outer contour and a socket part with an outer contour, the universal housing comprising:
a base shell having an inner contour and housing one of the plug part and the socket part;
a cover shell having an inner contour and placed onto said base shell, said cover shell housing the other of the plug part and the socket part; and
adapters each having an inner contour and an outer contour, one of said adapters inserted into each of said base shell and said cover shell, said outer contour of said adapters matched to said inner contour of said base shell and said cover shell, and said inner contour of said adapters being complementary to the outer contour of said socket part and of the plug part.
